(19) United States
(12) Patent Application Publication
(10) Pub. No.: US 2007/0205606 A1
(43) Pub. Date: Sep. 6, 2007

(54) DUAL BACKSET LATCH ASSEMBLY FOR LOCK

(75) Inventor: Mu-Lin Shen, Tainan (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: I-TEK METAL MFG. CO., LTD., Annan (TW)

(21) Appl. No.: 11/308,090

(22) Filed: Mar. 6, 2006

(51) Int. Cl. E05C 1/00

(52) U.S. Cl. 292/1.5

(57) ABSTRACT

A dual backset latch assembly includes a housing, a latch, a casing, a transmission member, an auxiliary plate, and a retractor. The retractor and the auxiliary plate are jointly movable for selective engagement with one of first and second mounting positions in a slot of the casing corresponding to shorter and longer backset lengths. When the retractor is in the first mounting position, a first mounting hole and a second mounting hole of the casing are respectively aligned with a first through-hole and a second through-hole of the auxiliary plate and respectively extended through by two mounting posts. When the retractor is in the second mounting position, a third mounting hole of the casing is aligned with the first through-hole of the auxiliary plate and extended through by one of the mounting posts, with the other mounting post extending through the second through-hole of the auxiliary plate.

### BACKGROUND OF THE INVENTION

1. Field of the Invention

The present invention relates to a latch assembly for a lock. More particularly, the present invention relates to a latch assembly for a lock with an adjustable backset.

2. Description of the Related Art

U.S. Pat. No. 5,551,736 discloses a dual backset deadbolt assembly for a cylinder lock. The dual backset deadbolt assembly is adjustable between a shorter backset length (60 mm) and a longer backset length (70 mm) and comprises a deadbolt housing, a deadbolt, an extension housing, an auxiliary mounting plate, a transmission plate, a first cam drive unit, and a second cam drive unit. The second can drive unit is movable between two positions for adjusting the backset. However, the structure of the dual backset deadbolt assembly is complicated, leading to troublesome and expensive manufacturing and assembling procedures.

### BRIEF SUMMARY OF THE INVENTION

A dual backset latch assembly for a lock in accordance with the present invention comprises a housing, a latch, a casing, a transmission member, an auxiliary plate, and a retractor. The latch is movable in a longitudinal direction between a retracted position inside the housing and an extended position outside the housing. The casing extends from a rear end of the housing. The casing comprises a slot including a first mounting position and a second mounting position. The casing further comprises a first mounting hole and a second mounting hole respectively on two sides of the slot. The casing further comprises a third mounting hole between the first mounting hole and the slot. The transmission member comprises a front end operably connected to the latch to move therewith. The auxiliary plate is mounted in the casing and movable in the longitudinal direction. The auxiliary plate comprises a first through-hole, a second through-hole, and a retractor mounting hole. The retractor is rotatably mounted in the retractor mounting hole of the auxiliary plate. The retractor and the auxiliary plate are jointly movable in the longitudinal direction for selective engagement with one of the first mounting position and the second mounting position of the casing. The retractor includes a central hole adapted to be extended through by a spindle of a lock. The retractor further includes two teeth for engaging with a rear end of the transmission member.

When the retractor is in the first mounting position of the casing, the latch assembly has a shorter backset length. The first mounting hole and the second mounting hole of the casing are respectively aligned with the first through-hole and the second through-hole of the auxiliary plate and respectively adapted to be extended through by two mounting posts of the lock.

When the retractor is in the second mounting position of the casing, the latch assembly has a longer backset length. The third mounting hole of the casing is aligned with the first through-hole of the auxiliary plate and adapted to be extended through by one of the mounting posts of the lock. The second through-hole of the auxiliary plate is outside the casing and adapted to be extended through by the other mounting post of the lock.

Preferably, the rear end of the transmission member comprises two spaced arms each having a front protrusion and a rear protrusion spaced in the longitudinal direction. When the retractor is in the first mounting position, the teeth of the retractor are adjacent to the front protrusions of the transmission member. When the retractor is in the second mounting position, the teeth of the retractor are adjacent to the rear protrusions of the transmission member.

Preferably, the retractor is a cylindrical body having the central hole through which the spindle of the lock extends. The cylindrical body includes a flange on which the teeth are formed.

Preferably, the casing comprises a firs side board and a second side board securely engaged with the first side board.

By such an arrangement, the backset of the latch assembly can be adjusted between two standard backset lengths (i.e., 60 mm and 70 mm) while having a simplified structure, allowing simple and inexpensive manufacturing and assembling procedures, especially the auxiliary plate and the retractor.

Other objectives, advantages, and novel features of the invention will become more apparent from the following detailed description when taken in conjunction with the accompanying drawings.

### BRIEF DESCRIPTION OF THE DRAWINGS

FIG. 1 is an exploded perspective view of a portion of a door and a door lock with a dual backset latch assembly in accordance with the present invention.

FIG. 2 is a side view, partly sectioned, of the door and the door lock in FIG. 1.

FIG. 3 is a perspective view of the dual backset latch assembly in accordance with the present invention.

FIG. 4 is an exploded perspective view of the dual backset latch assembly in accordance with the present invention.

FIG. 5 is a sectional view taken along plane 5-5 in FIG. 2, wherein the dual backset latch assembly has a shorter backset length.

FIG. 6 is a view similar to FIG. 5, wherein a latch is in a retracted position.

FIG. 7 is a perspective view similar to FIG. 3, wherein the dual backset latch assembly has a longer backset length.

FIG. 8 is a view similar to FIG. 2, wherein the dual backset latch assembly has a longer backset length.

FIG. 9 is a sectional view taken along plane 9-9 in FIG. 8.

FIG. 10 is a sectional view similar to FIG. 9, wherein the latch is in a retracted position.

### DETAILED DESCRIPTION OF THE INVENTION

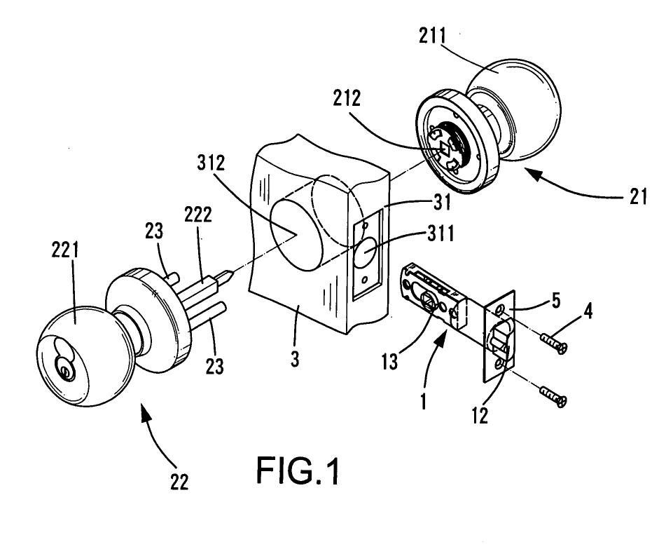

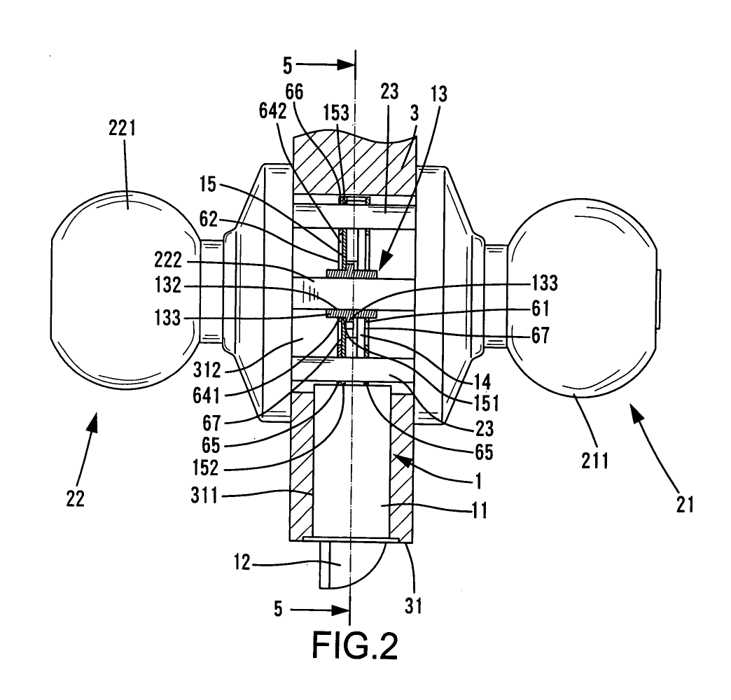

FIG. 1 is an exploded perspective view of a portion of a door 3 and a door lock with a dual backset latch assembly 1 in accordance with the present invention. FIG. 2 is a side view, partly sectioned, of the door 3 and the door lock in FIG. 1. The door lock comprises an inner assembly 21 and an outer assembly 22 respectively mounted to an inner side and an outer side of the door 3. Two mounting posts 23 are provided for mounting the inner and outer assemblies 21 and 22 to the door 3. The door 3 includes a bore 312 for accommodating elements of the inner and outer assemblies 21 and 22.

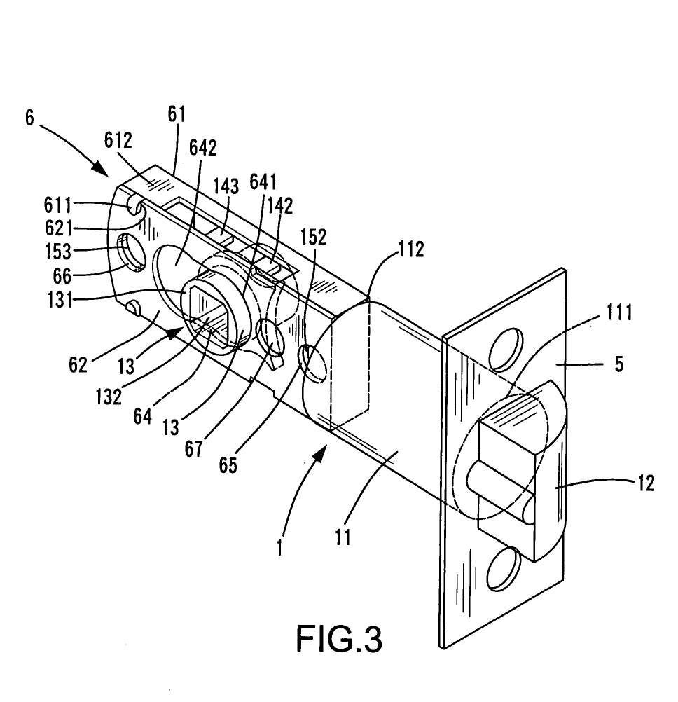

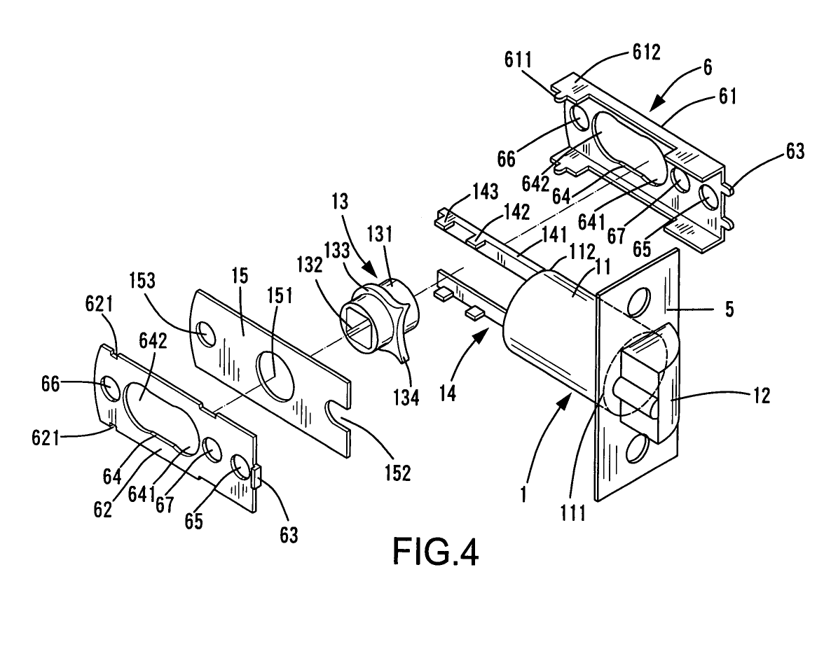

Referring to FIGS. 3 and 4, the dual backset latch assembly 1 in accordance with the present invention comprises a housing 11, a casing 6, a retractor 13, a transmission member 14, an auxiliary plate 15, and a latch 12. The latch assembly 1 is mounted into a compartment 311 in an edge 31 of the door 3 that is in communication with the bore 312 of the door. Screws 4 are extended through a faceplate 5 fixed on an end of the housing 11, thereby fixing the latch assembly 1 in the compartment 311 of the door 3.

The outer assembly 22 comprises an outside handle 221 and a spindle 222 connected to the outside handle 221 to turn therewith. The spindle 222 extends through the retractor 13 of the latch assembly 1 into a receptacle 212 of the inner assembly 21. When an inside handle 211 of the inside assembly 21 or the outside handle 221 is turned, the spindle 222 turns the retractor 13 for retracting the latch 12.

Still referring to FIGS. 3 and 4, the housing 11 of the latch assembly 1 includes a front end 111 to which the faceplate 5 is securely mounted and a rear end 112. The latch 12 is moveable between an extended position outside the housing 11 and a retracted position inside the housing 11. Also mounted in the housing 11 are a spring (not shown) and a plurality of conventional members (not shown) for moving the latch 12 between the extended position and the retracted position.

The casing 6 extends rearward from the rear end 112 of the housing 11 and receives the transmission member 14, the auxiliary plate 15, and the retractor 13. In this example, the casing 6 includes a first side board 61 and a second side board 62 spaced from the first side board 61. Each of the first side board 61 and the second side board 62 includes an engaging portion 63 on a front end thereof. The engaging portions 63 extend into and fixed in the housing 11. Further, two lugs 611 are formed on a rear end 612 of the first side board 61 and engage with notches 621 in a rear end of the second side board 62. The lugs 611 are bent after engaged in the notches 621, allowing firm engagement between the first and second side boards 61 and 62.

Each of the first and second side boards 61 and 62 further includes a slot 64 having a first mounting portion 641 and a second mounting portion 642. The first mounting portion 641 and the second mounting portion 642 of the slot 64 of the first side board 61 are preferably respectively aligned with the first mounting portion 641 and the second mounting portion 642 of the slot 64 of the second side board 62. When the retractor 13 is mounted in the first mounting portions 641, the latch assembly 1 has a shorter backset length (e.g., 60 mm). On the other hand, the latch assembly 1 has a longer backset length (e.g., 70 mm) when the retractor 13 is mounted in the second mounting portions 642.

Still referring to FIGS. 3 and 4, each of the first and second side boards 61 and 62 further includes a first mounting hole 65 and a second mounting hole 66 respectively on two sides of the slot 64. Further, each of the first and second side boards 61 and 62 further includes a third mounting hole 67 between the slot 64 and the first mounting hole 65. When the retractor 13 is mounted in the first mounting portions 641 (the first mounting position of the casing 6), the mounting posts 23 respectively extend through the first mounting holes 65 and the second mounting holes 66. On the other hand, when the retractor 13 is mounted in the second mounting portions 642 (the second mounting position of the casing 6), one of the mounting posts 23 extends through the third mounting holes 67.

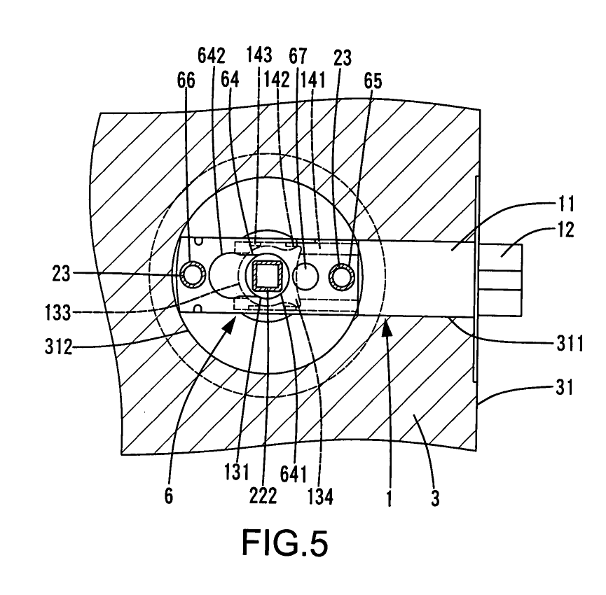

Referring to FIGS. 4 and 5, the transmission member 14 is received in the casing 6 and slidable in a longitudinal direction (i.e., the moving direction) of the latch 12. The transmission member 14 includes a front end (not shown) operably connected to the latch 12 to move therewith and a rear end having a pair of spaced arms 141. Each arm 141 includes two protrusions 142 and 143 spaced in the longitudinal direction of the latch 12.

Referring to FIG. 4, the auxiliary plate 15 is mounted in the casing 6 and movable in the longitudinal direction of the housing 11 or casing 6 (also the moving direction of the latch 12). The auxiliary plate 15 includes a retractor mounting hole 151, a first through-hole 152, and a second through-hole 153. The retractor 13 is rotatably engaged in the retractor mounting hole 151 of the auxiliary plate 15. Further, the retractor 13 and the auxiliary plate 15 may together move in the longitudinal direction of the housing 11 between the first mounting position and the second mounting position.

When the retractor 13 is mounted in the first mounting portions 641 (the first mounting position of the casing 6), the first through-hole 151 and the second through-hole 152 of the auxiliary plate 15 are respectively aligned with the first mounting holes 65 and the second mounting holes 66 of the casing 6. Thus, the mounting posts 23 respectively extend through the first through-hole 152 and the second through-hole 153 of the auxiliary plate 15, as shown in FIGS. 2 and 5.

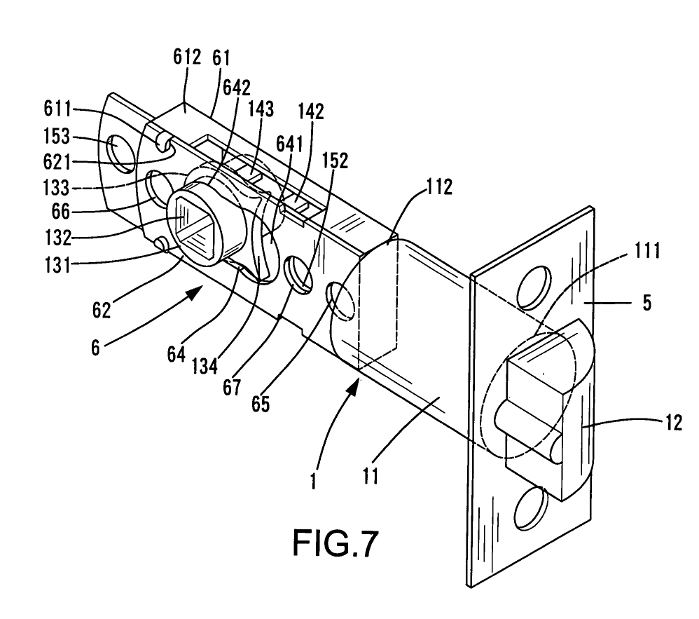

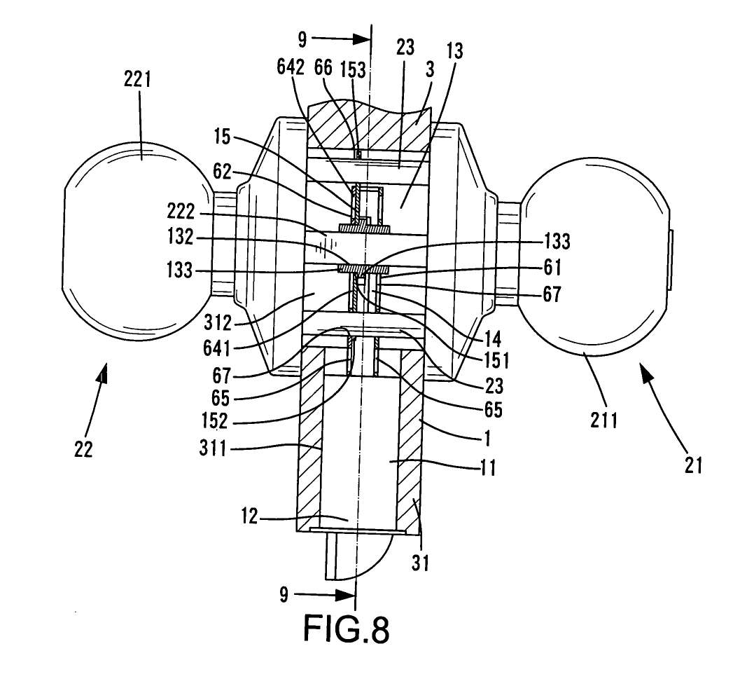

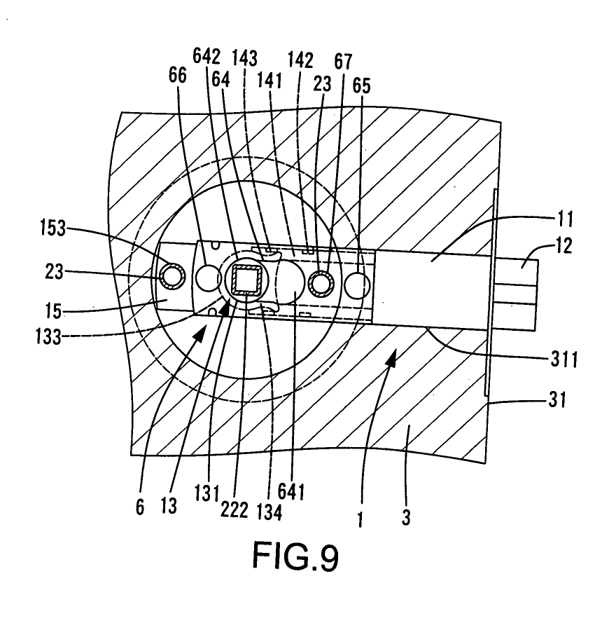

On the other hand, when the retractor 13 is mounted in the second mounting portions 642 (i.e., the retractor 13 is moved to the second mounting position of the casing 6, and the second through-hole 153 of the auxiliary plate 15 is outside the casing 6, see FIG. 7), the first through-hole 152 of the auxiliary plate 15 is aligned with the third mounting holes 67, and the second through-hole 153 of the auxiliary plate 15 is outside the casing 6. One of the mounting posts 23 extends through the third mounting holes 67 of the casing 6 and the first through-hotel 52 of the auxiliary plat 15 whereas the other mounting post 23 extends through the second through-hole 153 of the auxiliary plate 15, as shown in FIGS. 8 and 9.

The retractor 13 comprises a cylindrical body 131 rotatably engaged in the retractor mounting hole 151 of the auxiliary plate 15 and one of the first mounting position and the second mounting position (see the first and second mounting portions 641 and 642. The cylindrical body 131 includes a hole 132 through which the spindle 222 extends, allowing joint rotation of the retractor 13 and either handle 211, 221. A flange 133 is formed on an outer periphery of the cylindrical body 131 and includes two spaced teeth 134 for selective engagement with one of the protrusions 142 and 143 of the transmission member 14.

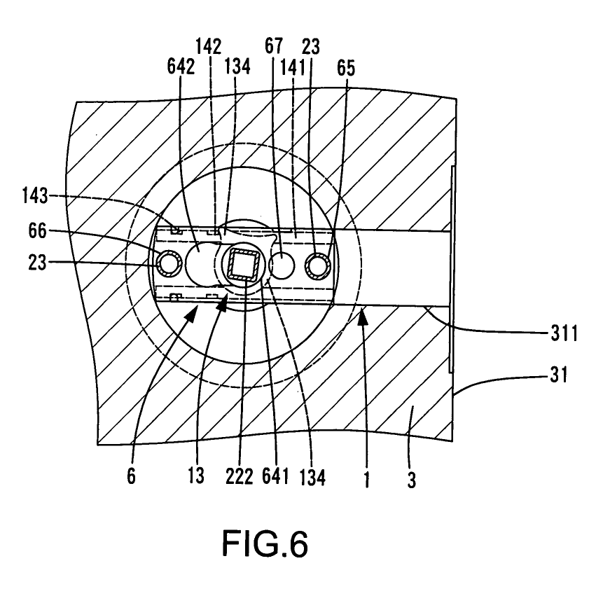

Referring to FIG. 5, in a case that the retractor 13 is mounted in the first mounting portions 641 of the casing 6 (the latch assembly 1 has a shorter backset length of 60 mm), the teeth 134 of the retractor 13 are adjacent to the front protrusions 142 of the transmission member 14 when the latch 12 is in the extended position. When either handle 211, 221 is turned, the spindle 222 drives the retractor 13 to turn. One of the teeth 134 of the retractor 13 engages with one of the front protrusion 142 of the transmission member 14 and moves the transmission member 14 rearward, thereby retracting the latch 12 to the retracted position, as shown in FIG. 6.

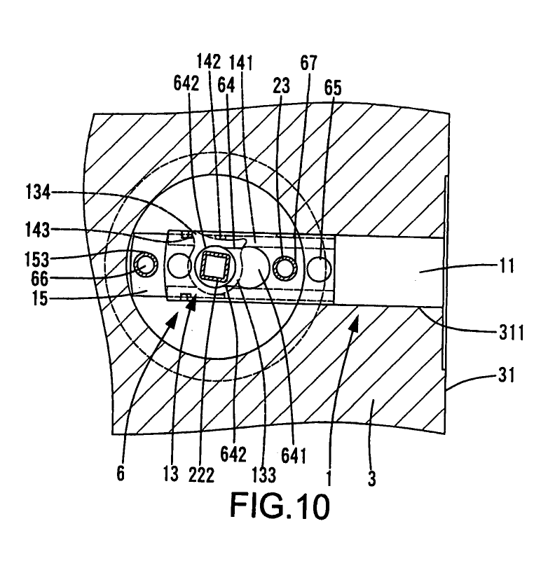

Referring to FIG. 9, in a case that the retractor 13 is mounted in the second mounting portions 642 of the casing 6 (the latch assembly 1 has a longer backset length of 70 mm), the teeth 134 of the retractor 13 are adjacent to the rear protrusions 143 of the transmission member 14 when the latch 12 is in the extended position. When either handle 211, 221 is turned, the spindle 222 drives the retractor 13 to turn. One of the teeth 134 of the retractor 13 engages with one of the rear protrusion 143 of the transmission member 14 and moves the transmission member 14 rearward, thereby retracting the latch 12 to the retracted position, as shown in FIG. 10.

Thus, the backset of the latch assembly 1 can be adjusted between two standard backset lengths (i.e., 60 mm and 70 mm) while having a simplified structure, allowing simple and inexpensive manufacturing and assembling procedures as compared to the conventional devices, especially the auxiliary plate 15 and the retractor 13. More specifically, in the dual backset deadbolt assembly disclosed in U.S. Pat. No. 5,551,736, two cam drive units are required for adjusting the backset length, whereas a single, integral retractor 13 is used in the dual backset latch assembly 1 in accordance with the present invention. The manufacturing and assembling costs of the dual backset latch assembly 1 in accordance with the present invention are thus lower. Further, the auxiliary mounting plate in the dual backset deadbolt assembly disclosed in U.S. Pat. No. 5,551,736 for adjusting the backset length is complicated in structure and thus requires troublesome and expensive manufacturing procedures. By contrast, the auxiliary plate 15 in the dual backset latch assembly 1 in accordance with the present invention is a flat plate with two through-holes 152 and 153 and a retractor mounting hole 151. The manufacturing cost is thus low.

Although specific embodiments have been illustrated and described, numerous modifications and variations are still possible without departing from the essence of the invention. The scope of the invention is limited by the accompanying claims.

What is claimed is:

1. A dual backset latch assembly for a lock, comprising:
a housing including a rear end;
a latch movable in a longitudinal direction between a retracted position inside the housing and an extended position outside the housing;
a casing extending from the rear end of the housing, the casing comprising a slot including a first mounting position and a second mounting position, the casing further comprising a first mounting hole and a second mounting hole respectively on two sides of the slot, the casing further comprising a third mounting hole between the first mounting hole and the slot;
a transmission member comprising a front end operably connected to the latch to move therewith, the transmission member further comprising a rear end;
an auxiliary plate mounted in the casing and movable in the longitudinal direction, the auxiliary plate comprising a first through-hole, a second through-hole, and a retractor mounting hole; and
a retractor rotatably mounted in the retractor mounting hole of the auxiliary plate, the retractor and the auxiliary plate being jointly movable in the longitudinal direction for selective engagement with one of the first mounting position and the second mounting position of the casing, the retractor including a central hole adapted to be extended through by a spindle of a lock, the retractor further including two teeth for engaging with the rear end of the transmission member;
wherein when the retractor is in the first mounting position of the casing, the latch assembly has a shorter backset length, with the first mounting hole and the second mounting hole of the casing being respectively aligned with the first through-hole and the second through-hole of the auxiliary plate and respectively adapted to be extended through by two mounting posts of the lock; and
wherein when the retractor is in the second mounting position of the casing, the latch assembly has a longer backset length, with the third mounting hole of the casing being aligned with the first through-hole of the auxiliary plate and adapted to be extended through by one of the mounting posts of the lock, and with the second through-hole of the auxiliary plate being outside the casing and adapted to be extended through by the other mounting post of the lock.

2. The dual backset latch assembly for a lock as claimed in claim 1 wherein the rear end of the transmission member comprises two spaced arms each having a front protrusion and a rear protrusion spaced in the longitudinal direction,
wherein when the retractor is in the first mounting position, the teeth of the retractor are adjacent to the front protrusions of the transmission member, and
wherein when the retractor is in the second mounting position, the teeth of the retractor are adjacent to the rear protrusions of the transmission member.

3. The dual backset latch assembly for a lock as claimed in claim 1 wherein the retractor is a cylindrical body having the central hole through which the spindle of the lock extends, the cylindrical body including a flange on which the teeth are formed.

4. The dual backset latch assembly for a lock as claimed in claim 1 wherein the casing comprises a firs side board and a second side board securely engaged with the first side board.
